(19) United States
(12) Patent Application Publication
(10) Pub. No.: US 2023/0314566 A1
(43) Pub. Date: Oct. 5, 2023

(54) METHOD FOR DETECTING BURIED LONGITUDINAL STRUCTURES BY MEANS OF A GROUND-PENETRATING RADAR

(71) Applicant: COMMISSARIAT A L’ENERGIE ATOMIQUE ET AUX ENERGIES ALTERNATIVES, Paris (FR)

(72) Inventors: Alex PEREIRA DA SILVA, GRENOBLE (FR); Luc MARET, GRENOBLE (FR); Jean-Baptiste DORE, GRENOBLE (FR); Raffaele D'ERRICO, GRENOBLE (FR)

(21) Appl. No.: 18/126,909

(22) Filed: Mar. 27, 2023

(30) Foreign Application Priority Data
Mar. 29, 2022 (FR) 2202804

(51) Int. Cl. G01S 7/41; G01S 13/88; G01S 13/89

(52) U.S. Cl. CPC G01S 7/411; G01S 13/885; G01S 13/89

(57) ABSTRACT

A method for detecting buried longitudinal structures using a ground-penetrating radar, the method includes the steps of: acquiring a plurality of radar signals for a region of ground, determining, based on the radar signals, a 3D point cloud, each point corresponding to one radar detection and being geolocated in space, selecting, from the 3D point cloud, at least one set of points comprising a number of points higher than or equal to a minimum detection threshold allowing a longitudinal structure to be characterized, the points of the set being substantially aligned with one another.

### CROSS-REFERENCE TO RELATED APPLICATION

This application claims priority to foreign French patent application No. FR 2202804, filed on Mar. 29, 2022, the disclosure of which is incorporated by reference in its entirety.

### FIELD OF THE INVENTION

The invention relates to the field of ground-penetrating radars or georadars which cover all of the techniques making it possible to detect, locate or identify underground targets by means of a radio-frequency system.

### BACKGROUND

Underground targets are, for example, piping of different diameters and types (steel, PVC, cement, concrete, etc.) which may be buried at various depths.

One objective of ground-penetrating radars is to locate such objects with precision in order to be able to correctly map a subsurface, for example for safety needs during works.

The images delivered by a ground-penetrating radar contain unwanted elements that may be of a number of types (effect of antenna coupling, thermal noise, radio interference, etc.). When an object is irradiated by the radar, it reflects energy that may be measured. Since the ground is a non-uniform medium, imaging algorithms generally cause a clutter of points of interest to appear. This clutter consists of reflections of the radar signal from an interface between two segments of the ground of different natures or from a reflective object present in the ground (pebbles, stones).

One problem addressed by the present invention is that of detecting and mapping the presence of piping or more generally of longitudinal structures in the ground while decreasing the clutter of points of interest present in the 3D image reconstructed based on the acquired radar signals.

Clutter-decreasing techniques are widely addressed in the literature. Most existing techniques may be classed into two main categories: methods based on modelling of the clutter, and methods aiming to decrease clutter by filtering.

The main disadvantages of methods for modelling clutter reside in the fact that the performance of these techniques is dependent on the adopted clutter model, on the difficulty of precisely estimating the parameters of the model, and/or on prior knowledge of the response of the terrain without targets. Techniques based on modelling of the (clutter and target) signals are especially described in references [1], [2], [3], [4], and [5].

As regards techniques based on filtering clutter, one drawback is that certain methods of this kind as they filter the clutter degrade the signal corresponding to the targets, whereas others need to make the assumption that the clutter signal is stronger than that of the targets or that the frequency spectrum of the clutter signal is concentrated in a region different from that of the signal of the targets. Examples of such methods are given in references [6], [7] and [8].

Moreover, techniques based on shape detection via Hough transform are described in articles [9] and [10]. These methods are exclusively dedicated to 2D detection of the radargram of a ground-penetrating radar on a uniform grid. These methods are based on recognition of a parabola in a radargram for a radar with a single transmit-receive antenna (SISO device).

The invention provides a method for detecting longitudinal structures in a 3D cloud of points of interest that is determined based on a plurality of radar measurements of a region of ground. The proposed method is based on searching for similar or substantially collinear unit vectors corresponding to lines or more generally longitudinal shapes exhibiting consistency between various planes. Points that do not correspond to these detections are considered to belong to the clutter and are filtered out.

Contrary to methods for modelling clutter, the invention requires no assumption to be made in respect of a statistical model of the clutter.

Contrary to existing solutions based on the Hough transform, the provided solution is based on processing of a non-uniformly sampled 3D point cloud, each point corresponding to the potential detection of a region of interest.

### SUMMARY OF THE INVENTION

One subject of the invention is a method for detecting buried longitudinal structures using a ground-penetrating radar, the method comprising the steps of:
acquiring a plurality of radar signals for a region of ground,
determining, based on said radar signals, a 3D point cloud, each point corresponding to one radar detection and being geolocated in space, selecting, from the 3D point cloud, at least one set of points comprising a number of points higher than or equal to a minimum detection threshold allowing a longitudinal structure to be characterized, the points of said set being substantially aligned with one another

According to one particular aspect of the invention, the step of selecting at least one set of points comprises the iterative sub-steps of:
ordering the points of the 3D point cloud into a list to be processed and selecting the point on the list of highest intensity,
determining unit vectors the origin of which is said selected point and the direction of which is given by each of the other points of the 3D point cloud,
determining the set of points having substantially collinear unit vectors, if the number of points of said set is higher than or equal to said minimum detection threshold, then identifying said set of points as corresponding to a longitudinal structure and removing the points of said set from the list to be treated, else removing from the 3D point cloud and from the list to be processed said selected point of highest intensity,
iterating the sub-steps until the list to be processed is empty.

According to one particular aspect of the invention, the step of determining the set of points having substantially collinear unit vectors comprises the sub-steps of:
approximating the components of the unit vectors to a predetermined number of significant figures,
forming the set of points having substantially collinear unit vectors by selecting points the approximate components of which are identical and the most recurrent.

In one variant embodiment, the method further comprises the sub-steps of:
determining the dominant value of each approximate component in the set of all the unit vectors,
combining points having the same dominant value for the three components.

According to one particular aspect of the invention, the step of combining points of the same dominant value is carried out by selecting points having the same dominant values in at least two components.

According to one particular aspect of the invention, the step of determining the set of points having substantially collinear unit vectors comprises the sub-steps of:
computing the angle between each pair of unit vectors,
preserving points for which said angle is smaller than a predetermined threshold in absolute value.

According to one particular aspect of the invention, the step of determining the set of points having substantially collinear unit vectors comprises the sub-steps of:
converting the unit vectors into polar coordinates,
determining a histogram of the absolute values of the angular components of said unit vectors for each angular component, each histogram having a predetermined sampling increment,
determining the most recurrent angular values for each of the components,
preserving points having the most recurrent angular values in each component.

According to one particular aspect of the invention, the points of the 3D point cloud are geolocated using a geolocation device of the ground-penetrating radar.

According to one particular aspect of the invention, the radar signals are acquired for a plurality of planes in the region of ground.

Another subject of the invention is a ground-penetrating radar comprising at least one transmit antenna and at least one receive antenna and a device for detecting buried longitudinal structures in a region of ground, which is configured to execute the steps of the detecting method according to the invention.

Another subject of the invention is a computer program comprising code instructions for executing the method according to the invention when the program is executed by a processor.

Another subject of the invention is a processor-readable storage medium on which is stored a program comprising instructions for executing the method according to the invention, when the program is executed by a processor.

### BRIEF DESCRIPTION OF THE DRAWINGS

Other features and advantages of the present invention will become more clearly apparent on reading the following description with reference to the following appended drawings.

FIG. 1 shows a 3D reconstruction of a scene comprising a pipe and clutter with a radar acquisition method according to the prior art,

FIG. 2 shows a plurality of successive radar images of the scene of FIG. 1, said images being obtained with an acquisition method according to the prior art,

FIG. 3 shows a flowchart of a method for detecting longitudinal structures according to one embodiment of the invention,

FIG. 4 shows a schematic illustrating construction of a point cloud based on a plurality of successive radar images,

FIG. 5 shows a flowchart of one particular embodiment of the method illustrated in FIG. 3,

FIG. 6a shows an illustration of a step of the method of FIG. 5,

FIG. 6b shows an illustration of a step of the method of FIG. 5,

FIG. 6c shows an illustration of a step of the method of FIG. 5,

FIG. 6d shows an illustration of a step of the method of FIG. 5,

FIG. 6e shows an illustration of a step of the method of FIG. 5,

FIG. 6f shows an illustration of a step of the method of FIG. 5,

FIG. 6g shows an illustration of a step of the method of FIG. 5,

FIG. 6h shows an illustration of a step of the method of FIG. 5,

FIG. 6i shows an illustration of a step of the method of FIG. 5,

FIG. 6j shows an illustration of a step of the method of FIG. 5,

FIG. 7 schematically shows application of the method of FIG. 5 to the point cloud of FIG. 4,

FIG. 8 schematically shows the result of filtering the clutter as applied to the point cloud of FIG. 4,

FIG. 9 shows a schematic of a radar detecting system according to one embodiment of the invention.

### DETAILED DESCRIPTION

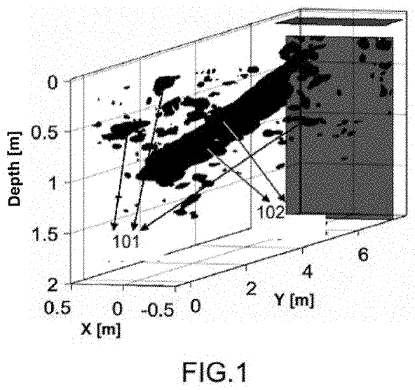

FIG. 1 shows a 3D reconstruction of a scene obtained by acquiring measurements using a ground-penetrating radar. The scene is characterized by the presence of a pipe. As explained in the preamble, the images generated based on the measurements acquired by a ground-penetrating radar contain unwanted elements referred to as clutter. In the example of FIG. 1, the 3D reconstruction of points of interest comprises points belonging to the pipe 102 that it is desired to detect but also points 101 belonging to the clutter.

The scene of FIG. 1 is constructed based on a plurality of radar images obtained for a plurality of successive cross-sectional planes of the 3D scene.

One objective of the invention is to decrease the points 101 belonging to the clutter so as to better detect the presence of a longitudinal structure such as a pipe, a pipeline or piping.

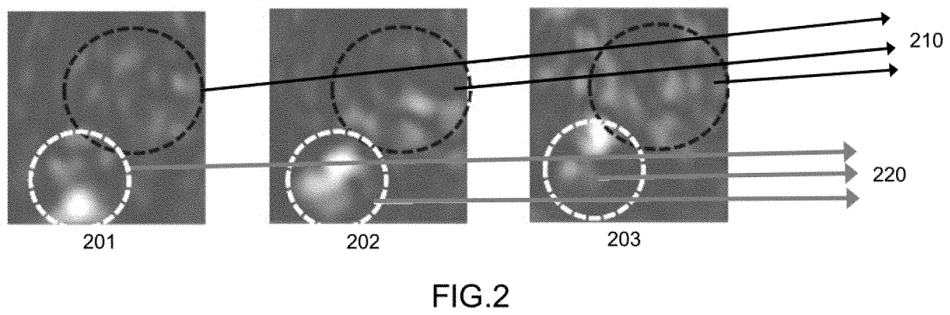

FIG. 2 shows three radar images 201, 202, 203 successively obtained for three different cross-sectional planes of the scene of FIG. 1.

On analysis of these three cross-sectional planes, it may be seen that the clutter 210 corresponds to noise that is coherent with the target to be detected, i.e. it may be of equivalent amplitude to a target in a radar image. However, the clutter 210 is not spatially coherent as the radar is moved along the scene. This is especially due to the fact that the clutter results from reflections of radar signals from objects that are very small or from interfaces between two types of ground that may vary spatially.

In contrast, it may be seen that an object such as a pipe is spatially coherent, i.e. the same amplitudes are found in the various images corresponding to various cross-sectional planes. In other words, the radar echoes of such a target are spatially correlated in various images corresponding to various cross-sectional planes.

This property is exploited by the invention to search, in a point cloud of the kind illustrated in FIG. 1, for rectilinear or longitudinal shapes, which correspond to the kind of target to be detected, namely pipes, pipelines or piping.

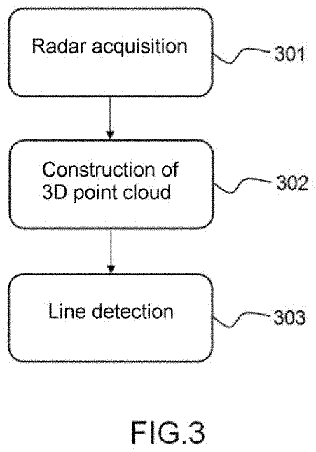

FIG. 3 schematically shows the steps for implementing a method for detecting longitudinal structures according to one embodiment of the invention.

The first step 301 consists in acquiring radar images of a plurality of cross-sectional planes of a region of ground, in order to obtain radar images of the kind illustrated in FIG. 2.

The radar images are acquired by means of a ground-penetrating radar comprising at least one transmit antenna and one receive antenna.

The radar is moved over the region to be imaged in order to perform a plurality of successive acquisitions. The raw signals measured are processed in order to generate a radar image each point of which has an intensity characteristic of the reflection of the signals from a buried target.

Step 301 of the method may for example be carried out by means of the acquisition method described in patent application FR 3111994 of the applicant. This application describes use of a so-called MIMO radar (MIMO standing for Multiple Input Multiple Output) having a plurality of transmit and receive antennas coupled to a demodulation algorithm that produces the radar image. Any other radar acquisition method allowing radar images of a plurality of cross-sectional planes of a 3D region may be used.

In step 302, a 3D point cloud is then constructed based on the various radar images of the cross-sectional planes of the scene. This step requires each image to be geolocated, in order to allow a position of the cross-sectional planes and therefore of the points to be deduced. Geolocation may be achieved by means of a device for receiving satellite radio-navigation signals, such as a GPS device, or of an odometer or more generally of any kind of locating device.

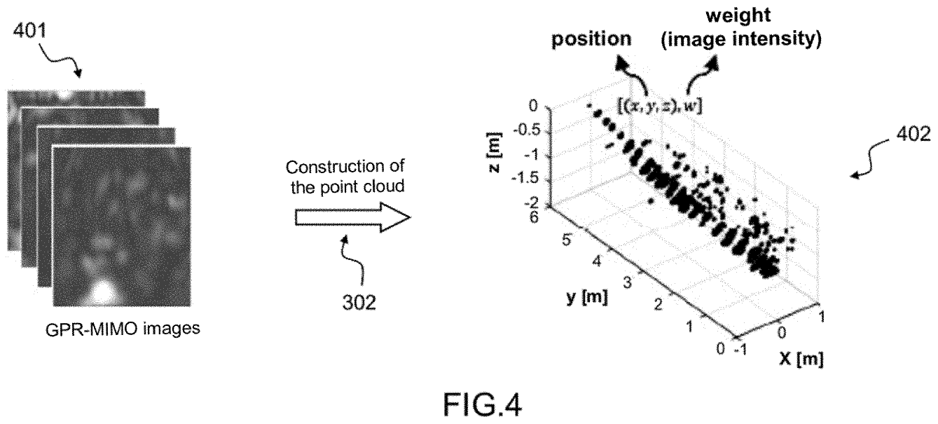

FIG. 4 illustrates step 302 in one example. The radar images 401 are converted into a three-dimensional point cloud 402 in which each point represents an intensity measured in the radar images and located in the 3D space by its spatial coordinates.

In step 303, a method for detecting aligned points in the 3D point cloud 402 is then applied in order to detect lines, corresponding to targets to be detected, and to remove points belonging to the clutter.

Step 303 is a step of searching for similar unit vectors, or in other words unit vectors that are substantially collinear between pairs of points forming thus a line.

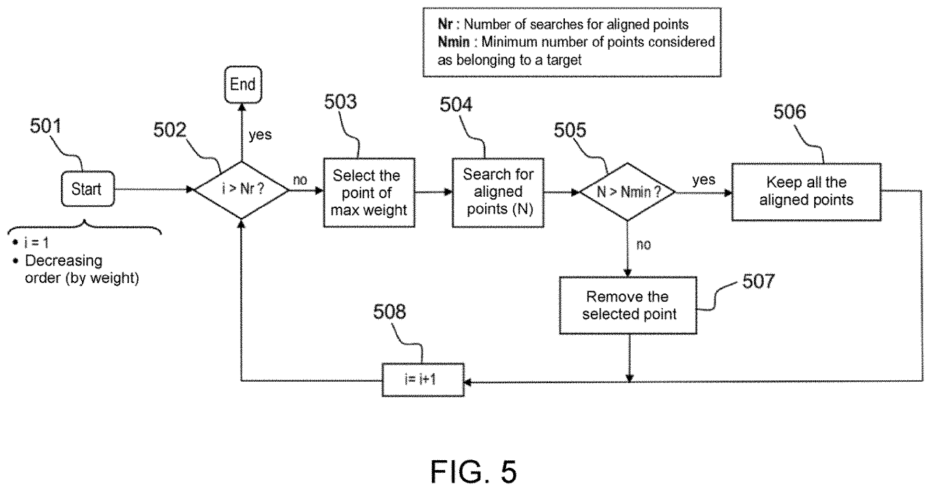

FIG. 5 illustrates in detail one example of implementation of step 303.

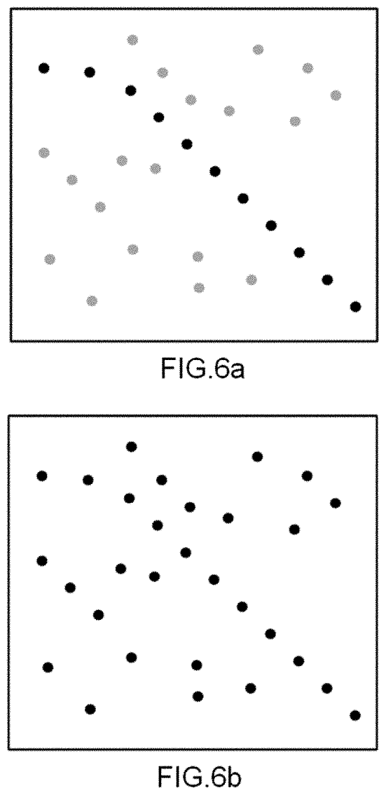

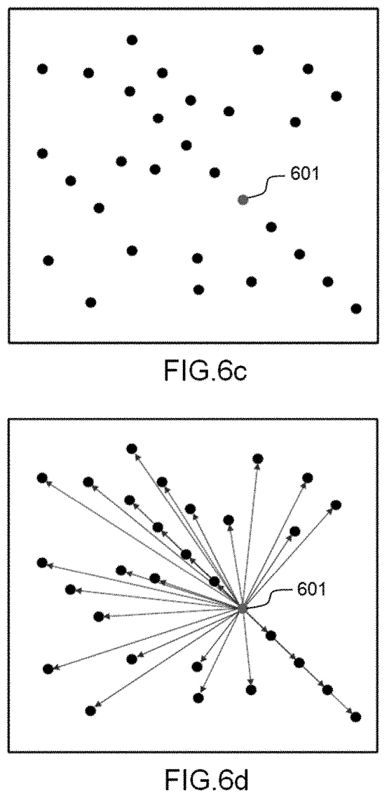

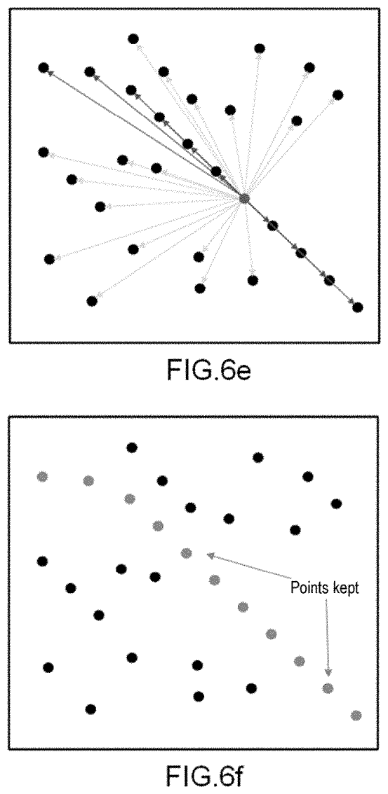

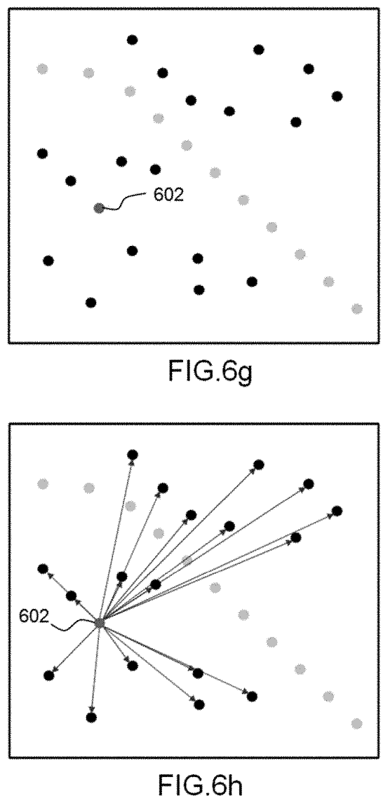

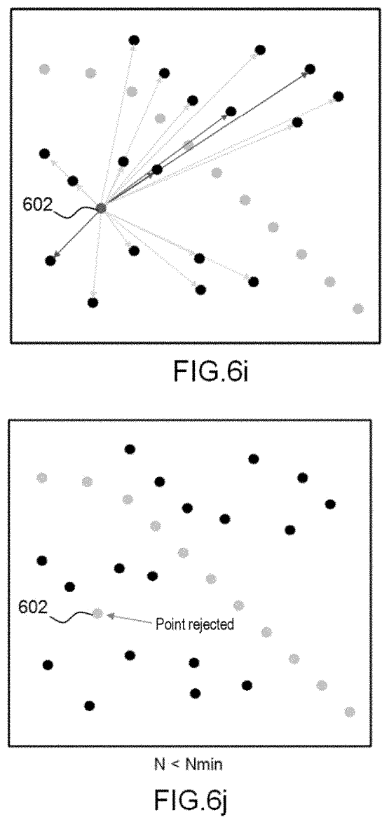

The algorithm of FIG. 5 is illustrated by an example given in FIGS. 6a to 6j.

FIG. 6b schematically shows a set of points of a 3D point cloud received as input of step 303. To simplify, the point cloud of FIG. 6b has been shown in two dimensions but the principle described applies identically to a cloud in three dimensions.

FIG. 6a shows the same point cloud, the darkest points identifying points that correspond to piping describing substantially a line.

The algorithm of FIG. 5 starts with a step 501 in which the points of the 3D point cloud are ordered in a list to be processed in order of decreasing amplitude.

An index i is initialized to 1 corresponding to the number of lines to be detected in the point cloud. In step 502, the method continues if i is lower than or equal to Nr the maximum number of lines that it is sought to detect.

In step 503, the first point of the list (that of highest amplitude) is selected. This step is illustrated in FIG. 6c by the point 601.

In step 504, the set of points that are aligned or substantially aligned with the selected point 601 is sought.

To do this, first all the unit vectors having as start point the selected point 601 and the direction of which is given by one of the other points of the point cloud are determined. This step is illustrated in FIG. 6d.

The unit vectors are given by the formula:

$${u}_{jk} = \frac{{p}_{j} - {p}_{k}}{‖ {p}_{j} - {p}_{k} ‖} ,$$

where pₖ is the start point 601 and pⱼ is the end point.

Among all the computed unit vectors, those that are substantially collinear with a predetermined margin of tolerance are retained. This step is shown in FIG. 6e.

There are a number of possible solutions that may be used to determine the set of substantially collinear vectors.

A first solution consists in executing the following steps.

Firstly, a rotation of 180° is applied to unit vectors a coordinate (for example the x-coordinate) of which is negative:

if uⱼₖₓ<0→uⱼₖ=−uⱼₖ

This step allows all the unit vectors almost aligned in a common direction to be obtained.

Next, each component of uⱼₖ is approximated to n significant digits. For example, n is set equal to 2 or 3. Use of n>3 is recommended only in a very noisy scenario.

Next, for each component, the dominant value among all the approximated unit vectors is computed. In other words, the largest set of vectors having the same approximate component value is sought.

Next, the results obtained for the three components x,y,z are combined in order to determine points that are almost aligned, with a tolerance given by the approximation by the number n.

One possible combination consists in collating all the points present in at least two projection planes. In other words, if the sets of indices of the points of the cloud with the most recurrent value of the components x,y,z are denoted Iₓ,I_{y},I_{z}, respectively, the set of almost aligned points is given by the following formula:

I=(Iₓ∩I_{y})∪(Iₓ∩I_{z})∪(I_{y}∩I_{z}), where ∪ designates the union operator and ∩ designates the intersection operator.

Another possible approach consists in measuring the angle between each pair of unit vectors and in preserving all of the points for which the absolute value of this angle does not exceed a predetermined threshold close to 0 and dimensioned to accept a certain tolerance in the alignment of the points.

A third possible approach consists in converting the unit vectors into spherical coordinates (r, θ, φ) and in introducing a tolerance into the angular variations of the angular components (θ, φ).

To do this, a histogram of the values of each angular component (θ, φ) is computed. The histogram is defined by an increment that gives the desired tolerance in the angular variation.

Next, the most recurrent values in these two histograms are determined by taking into account phase ambiguities (modulo π).

The sought set of almost aligned points corresponds to the intersection of the points having the most recurrent values of the two angular components, respectively.

At the end of step 504, a set of points that are almost aligned with the point selected in step 503 is obtained.

Next, in step 505, the number of points of the obtained set is compared with a threshold Nₘᵢₙ that is a minimum number of points that may be considered to belong to a target. This threshold is set depending on the type of structure that it is desired to detect. In the case of pipes, pipelines or piping, this threshold allows detection of objects of small size that may rather belong to the clutter to be excluded. The threshold value Nₘᵢₙ especially depends on the resolution of the movement of the radar. If the measurements carried out by the radar are very spaced apart spatially, the value of the threshold Nₘᵢₙ may be set very low. If in contrast the measurements are not very spaced apart, this value may be set higher. The value of the threshold Nₘᵢₙ also depends on the size of the 3D region scanned by the radar and on the length of the structures to be detected. The value of the threshold Nₘᵢₙ is for example set in the interval [10;50].

If the number of points of the set is strictly higher than Nₘᵢₙ then, in step 506, all the aligned points are preserved, these being associated with a detected structure. These points are then withdrawn from the list to be processed and the index i of the list is incremented (step 508) to pass to the following point of highest amplitude among the remaining points.

If the number of points of the set is lower than or equal to Nₘᵢₙ then the point selected in step 503 is removed (step 507) from the list to be processed and is considered to belong to the clutter—it is therefore filtered from the 3D point cloud.

Steps 505 to 507 are illustrated in FIGS. 6f to 6j. FIG. 6f illustrates the almost aligned points preserved after the first iteration.

FIG. 6g shows a 2nd iteration of the process with selection of another point 602 of highest amplitude among the points remaining in the list to be processed. FIG. 6h shows the unit vectors computed based on the point 602.

FIG. 6i shows the almost aligned points preserved. In this example, the number of almost aligned points is lower than Nₘᵢₙ and therefore point 602 is filtered (FIG. 6j).

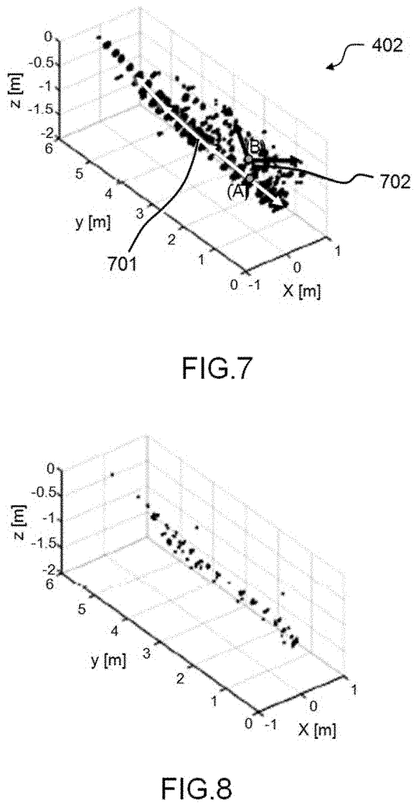

FIG. 7 schematically shows the result of the method on the 3D point cloud with the set of almost aligned points 701 corresponding to a longitudinal structure to be detected and the unaligned points 702 corresponding to the clutter.

FIG. 8 shows the 3D point cloud obtained after removal of the points corresponding to the clutter.

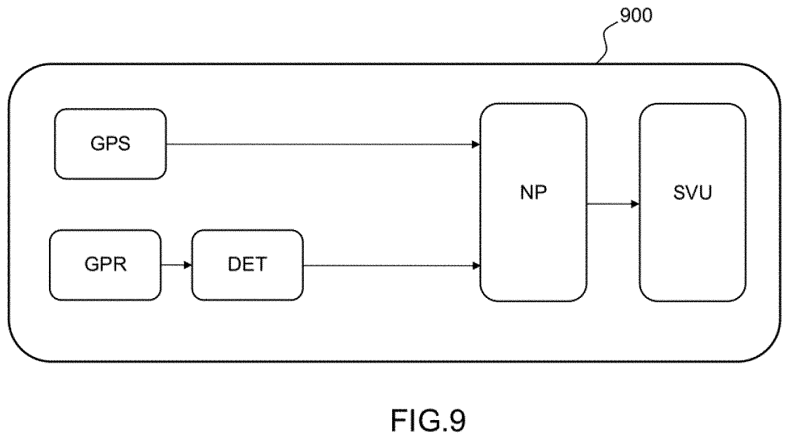

FIG. 9 schematically shows a radar detecting device according to the invention. The device 900 comprises a module GPR for acquiring radar signals, a geolocation module GPS, a radar detecting module DET allowing radar images of a plurality of planes of a region of ground to be generated based on radar signals acquired by the module GPR. A module NP for creating a 3D point cloud is applied to the obtained radar images taking into account geolocation information. In the case where the radar detecting module DET implements a MIMO detection algorithm, a step of binary thresholding may be applied to the radar images in order to preserve only points corresponding to detection of potential targets. Lastly, a module SVU for detecting longitudinal structures configured to execute the steps of searching for similar unit vectors as described above is applied to the point cloud.

The various modules DET,SB,NP,SVU may be produced in software and/or hardware form, notably using one or more processors and one or more memories. The processor may be a generic processor, a specific processor, an application-specific integrated circuit (ASIC) or a field-programmable gate array (FPGA).

The invention may be implemented alone or in combination with other line-detecting techniques that are applicable in a complementary manner to the filtered 3D point cloud obtained by the present invention.

The invention especially allows the number of points of the point cloud to be decreased by preserving only points belonging to almost linear targets. The obtained point cloud is thus more parsimonious and may be input into another more precise detection algorithm.

Generally, the invention allows points corresponding to the clutter to be significantly decreased.

### REFERENCES

[1] G. Zhan, L. Tsang, and K. Pak, “Studies of the angular correlation function of scattering by random rough surfaces with and without a buried object,” IEEE Trans. Geosci. Remote Sens., vol. 35, no. 2, pp. 444-453, March 1997.
[2] T. Dogaru and L. Carin, “Time-domain sensing of targets buried under a rough air-ground interface,” IEEE Trans. Antennas Propag., vol. 46, no. 3, pp. 360-372, March 1998.
[3] J. Brooks, L. van Kempen, and H. Sahli, “A primary study in adaptive clutter reduction and buried minelike target enhancement from GPR data,” in Proc. SPIE Detection and Remediation Technology for Mines and Minelike Targets V, 2000, pp. 1183-1192.
[4] M. El-Shenawee and C. Rappaport, “Monte Carlo simulations for clutter statistics in minefields: AP-mine-like-target buried near a dielectric object beneath 2-D random rough surfaces,” IEEE Trans. Geosci. Remote Sens., vol. 40, no. 6, pp. 1416-1426, June 2002.
[5] D. D. Carevic, M. Craig, and I. Chant, “Modelling GPR echoes from landmines using linear combination of exponentially damped sinusoids,” in Proc. SPIE Detection and Remediation Technology for Mines and Minelike Targets II, 1998, vol. 3079, pp. 1022-1032.
[6] Raffaele Solimene, A. Cuccaro, A. Dell'Aversano, Ilaria Catapano and Francesco Soldovieri, “Ground Clutter Removal in GPR Surveys”. IEEE journal of selected topics in applied earth observations and remote sensing, vol. 7, no. 3, March 2014
[7] U. S. Khan and W. Al-Nuaimy, “Background removal from GPR data using Eigen values,” presented at the 13th Int. Conf. Ground Penetrating Radar (GPR), Lecce, Italy, 2010.
[8] R. Solimene and A. D'Alterio, “Entropy based clutter rejection for intra-wall diagnostics,” Int. J. Geophys., vol. 2012, p. 7, 2012.
[9] Capineri, Lorenzo et al. “Advanced image-processing technique for real-time interpretation of ground-penetrating radar images.” International Journal of Imaging Systems and Technology 9 (1998)
[10] Carlotto, Mark, “Detecting buried mines in ground penetrating radar using a Hough transform approach”. Proceedings of SPIE—The International Society for Optical Engineering, 4741. 10.1117/12.478719, 2002.

1. A method for detecting buried longitudinal structures using a ground-penetrating radar, the method comprising the steps of:
acquiring a plurality of radar signals for a region of ground,
determining, based on said radar signals, a 3D point cloud, each point corresponding to one radar detection and being geolocated in space,
selecting, from the 3D point cloud, at least one set of points comprising a number of points higher than or equal to a minimum detection threshold allowing a longitudinal structure to be characterized, the points of said set being substantially aligned with one another.

2. The detecting method according to claim 1, wherein the step of selecting at least one set of points comprises the iterative sub-steps of:
ordering the points of the 3D point cloud into a list to be processed and selecting the point on the list of highest intensity,
determining unit vectors the origin of which is said selected point and the direction of which is given by each of the other points of the 3D point cloud,
determining the set of points having substantially collinear unit vectors,
if the number of points of said set is higher than or equal to said minimum detection threshold, then identifying said set of points as corresponding to a longitudinal structure and removing the points of said set from the list to be treated, else removing from the 3D point cloud and from the list to be processed said selected point of highest intensity,
iterating the sub-steps until the list to be processed is empty.

3. The detecting method according to claim 2, wherein the step of determining the set of points having substantially collinear unit vectors comprises the sub-steps of:
approximating the numerical values of the components of the unit vectors in a 3D coordinate system to a predetermined number of significant figures,
forming the set of points having substantially collinear unit vectors by selecting points the approximate components of which are identical and the most recurrent.

4. The detecting method according to claim 3, further comprising the sub-steps of:
determining the dominant value of each numerical approximate-component value in the set of all the unit vectors,
combining points having the same dominant value for the three components of the 3D coordinate system.

5. The detecting method according to claim 4, wherein the step of combining points of the same dominant value is carried out by selecting points having the same dominant values in at least two components.

6. The detecting method according to claim 2, wherein the step of determining the set of points having substantially collinear unit vectors comprises the sub-steps of:
computing the angle between each pair of unit vectors,
preserving points for which said angle is smaller than a predetermined threshold in absolute value.

7. The detecting method according to claim 2, wherein the step of determining the set of points having substantially collinear unit vectors comprises the sub-steps of:
converting the unit vectors into polar coordinates,
determining a histogram of the absolute values of the angular components of said unit vectors for each angular component, each histogram having a predetermined sampling increment,
determining the most recurrent angular values for each of the components,
preserving points having the most recurrent angular values in each component.

8. The detecting method according to claim 1, wherein the points of the 3D point cloud are geolocated using a geolocation device of the ground-penetrating radar.

9. The detecting method according to claim 1, wherein the radar signals are acquired for a plurality of planes in the region of ground.

10. A ground-penetrating radar comprising at least one transmit antenna and at least one receive antenna and a device for detecting buried longitudinal structures in a region of ground, which is configured to execute the steps of the detecting method according to claim 1.

11. A computer program comprising instructions for executing the method according to claim 1, when the program is executed by a processor.

12. A processor-readable storage medium, on which is stored a program comprising instructions for executing the method according to claim 1, when the program is executed by a processor.
